(19) United States
(12) Patent Application Publication
(10) Pub. No.: US 2019/0312612 A1
(43) Pub. Date: Oct. 10, 2019

(54) COMMUNICATIONS ACCESSORY FOR AN ELECTRONIC DEVICE AND SYSTEM COMPRISING AN ACCESSORY

(71) Applicant: DRAYSON TECHNOLOGIES (EUROPE) LIMITED, London (GB)

(72) Inventors: Diana STEFAN, London (GB); Bruno FRANCISCATTO, London (GB); Manuel PINUELA, London (GB)

(73) Assignee: Drayson Technologies (Europe) Limited, London (GB)

(21) Appl. No.: 16/315,376

(22) PCT Filed: Jun. 29, 2017
(86) PCT No.: PCT/GB2017/051910

§ 371 Date: Jan. 4, 2019

(30) Foreign Application Priority Data
Jul. 7, 2016 (GB) 1611869.7

(51) Int. Cl. H04B 5/00; H02J 7/02; H02J 50/20; H02J 50/80

(52) U.S. Cl. CPC H04B 5/0037; H02J 50/80; H02J 50/20; H02J 7/025

(57) ABSTRACT

This application relates to a communications accessory (100) for an electronic device capable of harvesting energy from an electronic device to which it is attached in the field of wireless energy harvesting and communication. The accessory comprises a fixture, an energy store (10), an RF power harvester (12) comprising an electromagnetic field coupler, a data store (6), a wireless communication interface (8), a controller (4) and a user operable activator (2). The accessory can harvest RF energy which is then stored in the energy store (10). The accessory is also operable to communicate a message from the data store (6) in response to activation of the user operable activator (2).

The present invention relates to communications apparatus, and more particularly to accessories for augmenting communications functionality of electronic devices.

Multifunction communication devices are widespread. For example a smartphone typically combines the features of a cell phone, such as the ability to receive and make phone calls, with those of other popular digital mobile devices. Other features typically include a personal digital assistant (PDA) for making appointments in a calendar, media player, video games, GPS navigation unit, digital camera and digital video camera. Most smartphones can access the Internet and can run third-party software components (known as “apps”). This can enable smartphones to provide interfaces to sophisticated and secure databases such as those associated with banking records and electronic payment for ecommerce.

There is an expectation that smartphone devices will have very significant computing power—this has become the norm. It is also expected that they will have a variety of different communications capabilities such as a near field RF communication, short-distance radio communication such as Bluetooth, infrared communication such as IrDA, a Wi-Fi modem, and cellular network communications capability. Some also have FM radio tuners. The ability to provide such a variety of functionality in a single device has led to a continuing drive for further integration and further increases in the functionality offered by a single device. The functionality offered by smartphones and other mobile communications handsets such as tablet computers is now so advanced that the need for desktop computers in offices and other places of work is being reduced. The next stage in the use of multifunction devices is “Bring Your Own Device” in which workplace desktop computers are replaced by users' own mobile communications handsets. In this context, it would appear that the need for additional communications devices has been conclusively resolved—a single multipurpose handheld computer can deal with all a user's communications needs.

Aspects and embodiments of the present disclosure are set out in the claims and may augment communications functionality of existing electronic devices such as mobile communications handsets.

Embodiments of the present disclosure will now be described, by way of example only, with reference to the accompanying drawings in which:

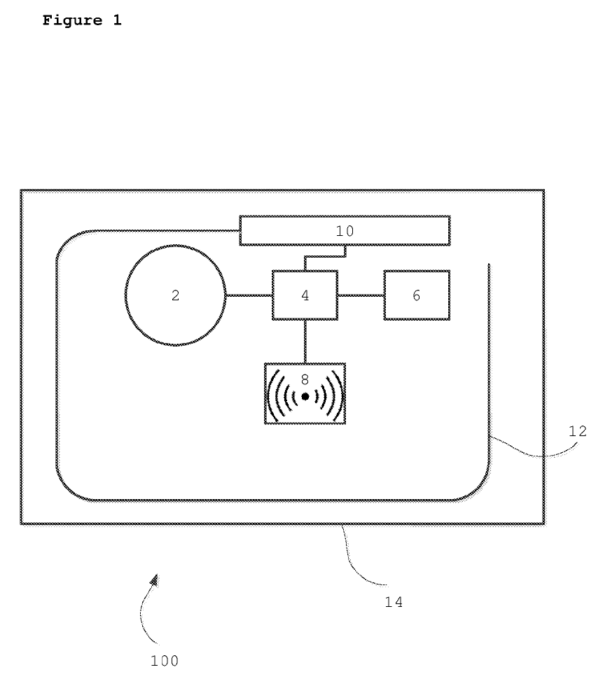

FIG. 1 shows a schematic diagram of an accessory for an electronic device;

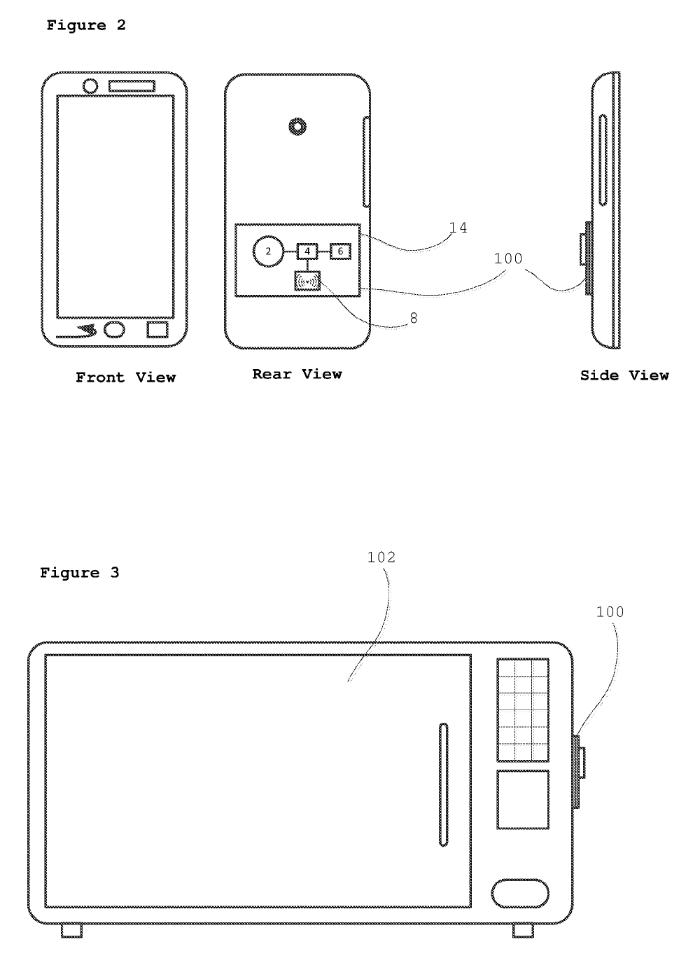

FIG. 2 shows a schematic diagram of an accessory such as that illustrated in FIG. 1 and having a particular arrangement of components, FIG. 2 includes plan side and end views of this accessory;

FIG. 3 shows a system comprising an electronic device and an accessory such as that shown in FIG. 1 or FIG. 2 and includes front, rear and side views of the system; and

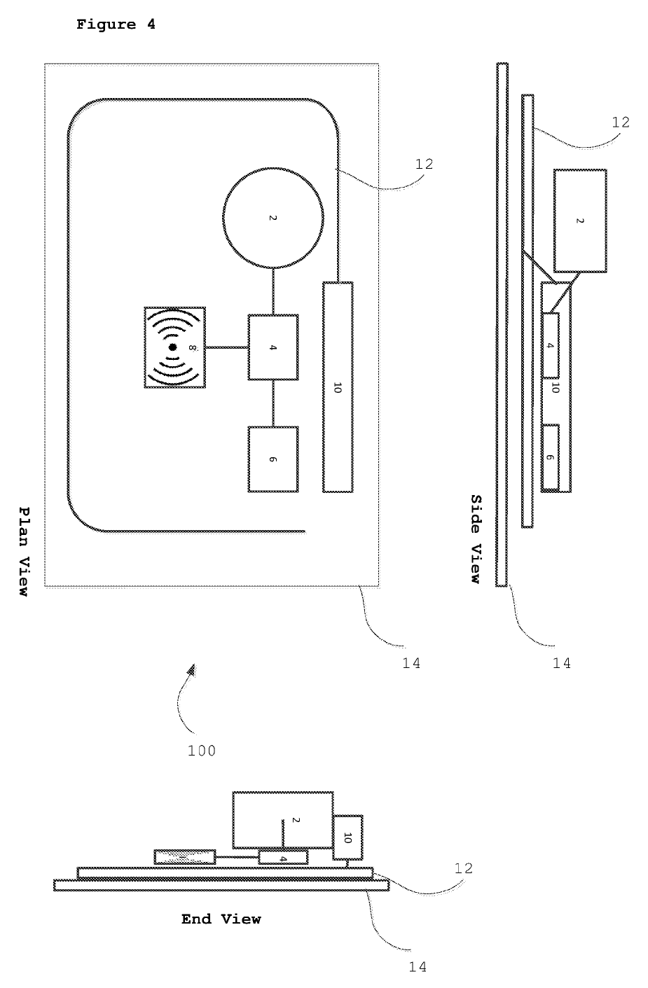

FIG. 4 shows another system such as that illustrated in FIG. 3.

In the drawings like reference numerals are used to indicate like elements.

FIG. 1 illustrates a communications accessory 100 having a wireless power harvester 12 and a user actuable button 2. The accessory 100 is configured to use power harvested from stray electromagnetic fields produced by a device to which it is secured to send a wireless message to that device in response to actuation of the user actuable button 2. This message may be forwarded by the device over a wide area communication network to provide a simple and reliable dedicated user interface for reporting predefined data.

The accessory 100 illustrated in FIG. 1 comprises a base 14 which has a fixture for securing the accessory 100 to a surface such as an external surface of an electronic device. The accessory 100 also comprises an energy store 10 for storing electrical energy harvested by the power harvester 12, a data store 6 storing message data, a wireless communication interface 8, a controller 4. The controller is configured to send messages over the wireless interface in response to actuation of the user actuable button.

The base 14 carries the fixture and all the other components. The controller is coupled to the energy store 10, the data store 6, the user actuable button 2 and the wireless communication interface 8. The energy store 10 is coupled to the power harvester 12.

The fixture may comprise an adhesive pad or other securement feature for fixing the base 14 to a housing of an electronic device. The fixture may be provided on a first surface of the base 14 and the user actuable button 2 may be carried on the other surface so that when in use the accessory 100 is secured to the device by the fixture the user actuable button 2 is presented to the user. It will be appreciated in the context of the present disclosure that the accessory 100 may be incorporated into a case of the electronic device—for example the fixture may itself comprise part of the housing of the electronic device.

The user actuable button 2 comprises a sensor configured to provide a signal to the controller in response to a selected user action. Examples of such actions include pushing a depressible surface of the button, and touching a sensing surface of the button.

The wireless communications interface comprises a short-distance communications interface operable to transmit wireless signals over distances of between a few centimetres and a few tens or hundreds of metres. Examples of suitable communications interfaces include Bluetooth® and other short range systems. The wireless communications interface is operable in a unicast mode, to send messages to a particular selected device and also in a broadcast mode. In the unicast mode the wireless communication interface 8 may be paired with a particular device for sending data only to that device. In the broadcast mode the wireless communication interface 8 may attempt to establish communication with any one of a plurality of devices in communication range. In the broadcast mode the wireless communication interface 8 may provide a beacon signal (such as a Bluetooth beacon) which transmits its own unique user ID and a few bytes of data. These bytes of data generally comprise message data, selected by the controller in response to actuation of the button and an address of a remote device to which the message data is to be sent. The beacon signal can cause a communications device which receives it to forward message data carried with the beacon signal over a wider area network to a remote device.

The energy store 10 is operable to store electrical energy provided by the power harvester 12. The energy store 10 may comprise a battery and/or a capacitor and/or a fuel cell for storing electrical charge.

The power harvester 12 may comprise an RF energy harvesting system such as that described in WO2015/019106, the entirety of which is hereby incorporated by reference. The power harvester 12 may comprise an electromagnetic field coupler such as an antenna arranged to couple with ambient RF energy—whether in the form of near field energy, often mediated by time varying H-fields, or mid-field and far-field energy, often mediated by time varying E-fields. The power harvester 12 may also comprise a rectifier and other components for providing usable electrical energy to the energy store 10. The power harvester comprises an electromagnetic field coupler which may be positioned relative to the base so that when in use the base is coupled to the housing of an electronic device the electromagnetic field coupler is arranged for coupling with a time varying H-field field generated by operation of electronic circuitry of the device.

Typically the data store 6 comprises non-volatile memory storing at least one item of message data accessible by the controller 4.

The controller comprises an input which is coupled to the user actuable button 2 for sensing actuation of the button. The controller comprises processing logic configured to respond to actuation of the button by obtaining message data from the data store 6, and transmitting a message comprising the message data via the wireless communication interface 8. The controller may also be configured to determine a power level of a device communicating with the wireless communications interface. This may be done using telemetry data communicated from the device using the short-distance communication interface e.g. using a telemetry frame which indicates battery level. The power level may also be determined in other ways—for example it may be estimated based on a power level of a signal received from that device or based on the presence or absence of communication from that device. For example, if no communication is received from the device for more than a selected time interval the controller may decide that the device is in a low power or sleep mode or has been switched off. The controller may be configured so that, in this eventuality, it switches the wireless communication interface 8 to operate in a broadcast mode so as to pair with any one or more other devices within communication range.

When it is in use, the accessory 100 is typically secured to a housing of an electronic device such as a smartphone or other source of electromagnetic energy. The electronic device which carries the accessory 100 may have its own short distance communication interface, and the communication interface of the accessory 100 can use this to establish a communication channel (e.g. a Bluetooth pairing or other link) with the electronic device. This can provide a unicast mode of communication from the accessory 100 to the electronic device which carries it. The unicast mode may also be established with another device in communication range of the accessory 100.

The power harvester 12 obtains energy from the electromagnetic radiation generated by the electronic device and uses this to charge the energy store 10. The energy store 10, when charged, provides power to the controller and to the user actuable button 2. In the event that the controller senses operation of the user actuable button, the controller selects message data from the data store 6 and sends it over the wireless communication interface 8.

The message data may be sent in a variety of forms. In one possibility, the message data comprises an identifier of the accessory and/or the device to which it is coupled. It may also comprise an indicator of the nature of the user's actuation of the button—for example one or more of: (i) the number of actuations, (ii) their timing (e.g. duration or frequency) and (iii) the force applied. This message data can be sent from the accessory to the electronic device which can then forward it over a wide area network to a remote device. In another possibility, the electronic device can use local settings, such as those provided by a software application installed on the device, to use the indicator to select the content of the message, and then to forward that message over the wide area network. In a third possibility, the message data stored in the data store may comprise a plurality of items of message data, and the controller of the accessory may select between them based on the nature of the user's actuation of the button—for example based on one or more of: (i) the number of actuations, (ii) their timing (e.g. duration or frequency) and (iii) the force applied. Accordingly, the message data sent to the electronic device from the accessory may be selected from the data store by the controller of the accessory. This can enable the accessory to provide the message content to the electronic device and the electronic device can then simply forward it on.

If the wireless communication interface 8 is operating in unicast mode the message data is sent to the electronic device, whereas if it is operating in the broadcast mode the message is sent to any one or more other devices which may be in communication range. Typically the message data comprises forwarding data to enable the device which receives the message to forward it over a wide area communications interface.

The message which is sent on from the electronic device may comprise location data indicating a geographic location of the device and accessory. This may be obtained from a GPS (global positioning system) functionality of the electronic device, or from similar functionality carried by the accessory. Location may also be determined using Wi-Fi methods or based on cellular telecommunications signals.

FIG. 2 illustrates a system comprising a mobile telecommunications handset and an accessory 100. The accessory 100 of the system illustrated in FIG. 2 may be provided by an accessory 100 such as that described above with reference to FIG. 1.

The accessory 100 illustrated in FIG. 2 also comprises a user actuable button 2, a controller 4. Although not shown in the drawing it also includes an energy store for storing electrical energy harvested from the handset. The controller is coupled to the energy store 10, the user actuable button 2 and the wireless communication interface 8. The user actuable button, the controller, and energy store 10 shown in FIG. 2 may have the features of the components described with reference to FIG. 1 and/or may provide the same or equivalent functions.

These components are carried by a base fixture adapted to be secured on a case of the handset. For example, this fixture may be integrated with a part of the case or secured to the case by a clip or adhesive foot. This may enable the accessory 100 to be carried on a rear surface or a side of the handset.

The base 14 may also comprise a power obtainer (not shown in FIG. 2) such as a power harvester 12 or other coupling for deriving power from the handset to charge the energy store 10. One example of a power harvester 12 is a power harvesting antenna comprising an electromagnetic field coupler for coupling with a time varying electromagnetic (e.g. an H-field or an E-field) generated by operation of the handset. The power harvester 12 may be arranged at or near the underside of the base 14, opposite to the side which carries the button. This may place the power harvester 12 in very close proximity to the handset when in use the accessory 100 is secured to a housing of the handset. In this configuration the power harvester 12 may be disposed closer to the housing of the handset than any of the other electrically conductive components of the accessory 100—this may promote efficient coupling with an H-field generated by the handset. The power harvester 12 may also be adapted to couple with E-fields generated by the handset. Indeed it may harvest power from any electromagnetic signal and may be preferentially tuned to a frequency band or bands associated with at least one: a Wi-Fi frequency band; and a telecommunications frequency band such as a GPRS frequency band or an LTE frequency band.

As with the accessory 100 illustrated in FIG. 1, the accessory 100 shown in FIG. 2 comprises a short range wireless communication interface 8 which is configured to provide signals to the handset from the accessory 100 in response to actuation of the button.

The handset is configured to respond to messages received from the accessory 100 over the short range link by sending a message via a telecommunications interface of the handset. The handset is configured to select the content of the message it sends based on the number of times a user actuates the button during a time interval, and/or the length of a delay between user actuations during the time interval. For example—a single isolated press of the button may cause the handset to send a first message, whereas a rapid double-click may cause the handset to send a second message, a slower double-click, or a series of three clicks, or some other sequence, may cause the sending of other different messages. In some examples the user actuable button 2 is arranged to provide a pressure dependent signal—indicating a force with which a user has pressed the button. It may also be arranged to provide an indication of the duration of a user actuation of the button. In these and other examples the controller 4 and/or the handset may be configured to select the message data based on these and other parameters of the user's operation of the button or other user operable activator provided by the accessory 100.

The accessory 100 may comprise a data store 6 storing a plurality of message data items. The controller 4 of the accessory 100 may provide these items of message data to the handset, for example this may be done at the time the accessory 100 is secured to the handset or it may be done when the short-range communication interface establishes communication with the handset.

As with the accessory 100 described with reference to FIG. 1, the accessory 100 illustrated in FIG. 2 is operable in a unicast mode—in which it is paired with the handset, and communicates only with the handset. It may also be operable in a broadcast mode for broadcasting the message to a plurality of other devices. When operating in the broadcast mode the short range communication interface may operate as a beacon. For example it may operate as a Bluetooth® beacon according to any one of a plurality of beacon protocols such as iBeacon, AltBeacon, URIBeacon, Eddystone or others. As explained above with reference to FIG. 1, the accessory 100 illustrated in FIG. 2 may also be configured to determine a power level of the handset and, in the event that the power level is less than a selected threshold level, to operate in this broadcast mode.

FIG. 2 shows one particular system in which the accessory 100 is secured to a mobile telecommunications handset, but other systems are envisaged. For example, as illustrated in FIG. 3 the accessories 100 of the present disclosure may also be coupled to domestic appliances such as a microwave oven 102.

FIG. 4 illustrates an accessory 100 having a particular arrangement of components.

The accessory 100 shown in FIG. 3 comprises a base 14 carrying a user actuable button 2. The button has a superior surface for sensing actuation by an operator and the base 14 is disposed on the opposite side of the button.

The accessory 100 also comprises a power harvesting antenna and an energy store 10 for storing electrical energy provided by the antenna. Electrically conductive elements, such as conductive traces or wires are arranged in the accessory 100 for providing power from the energy store 10 to other components of the accessory 100 and/or for providing transducer couplings which carry signals from the button to trigger actions such as communication with a device which carries the accessory 100.

The power harvesting antenna lies in or adjacent to the base 14. A conductor extends up out of the base 14 to the energy store 10, which perhaps incorporates rectifiers and regulators and other power management components.

The button is coupled to a controller 4. The controller 4 is coupled to a data store 6 for storing message data as explained above with reference to FIG. 1. The controller 4 may also be coupled to a short-distance communication interface such as a Bluetooth® chip. This may include a second antenna for short range wireless communications.

All of these components may be further from the base 14 than the power harvesting antenna—for example the components may all lie between the plane of the superior actuation surface of the button and the plane of the power harvesting antenna.

The features of the accessory 100 described with reference to FIG. 4 may be incorporated into any one or more of the accessories described herein.

The wireless communication interface 8 of the accessories and devices described herein may comprise a short-distance communication interface operable to transfer data between devices over a range of less than a few tens or hundreds of meters. Examples of such communications interfaces include wireless personal area networks (WPANs) such as: INSTEON, IrDA, Wireless USB, Bluetooth, Z-Wave, ZigBee and Body Area Networks. Bluetooth is a particularly useful example of a short distance communication interface which may be used in examples of the present disclosure. Bluetooth is a wireless communication technology that uses a frequency-hopping scheme in the unlicensed Industrial Scientific-Medical (ISM) band at 2.4 GHz other examples of short-distance communication may be used. In some embodiments the wireless communication interface 8 of the accessories and devices described herein may comprise a Wi-Fi interface for communication over a WLAN.

The wide area network described herein may be provided by any geographically dispersed telecommunications network such as the internet and may comprise packet switched and/or circuit switched elements such as POTS (plain old telephone services). It may comprise, at least in part, a cellular telecommunications network. The wide area communications interfaces described herein comprise any interface operable to communicate over such a network. Examples of such interfaces comprise modems for communication over packet switched networks, which may comprise wired and/or wireless components. Such interfaces may comprise GSM, GPRS, 3GPP, LTE and other mobile communications interfaces.

The accessories described herein are described as including a user actuable button 2. This may be operated by a user to activate the accessory 100. It will be appreciated by the skilled addressee in the context of the present disclosure that instead of a user actuable button 2 these accessories may comprise any use operable activator—examples include push buttons, switches, temperature sensors, light sensors, fingerprint scanners, microphones and any other device which can be operated by a user action to activate the accessory 100.

Some accessories described herein are described as including a fixture for securing the accessory 100 to an electronic device. It will be appreciated however that the accessories need not in practice be secured to such a device. They may harvest power from other sources and may function exactly as described herein provided that they are in range for communication via a wireless communication interface 8—for example a short distance communication interface such as Bluetooth®. It will be appreciated in the context of the present disclosure that typically such communication transfers data to the physical layer at the accessory 100 which generates physical layer signals (such as radio signals) for reception by the electronic device. The device then receives these physical layer signals generated by the accessory 100 and demodulates them to provide received data. For example, such communication may take place between two devices directly without the need to be mediated through other network hardware. As noted above, examples of such communications interfaces include wireless personal area networks (WPANs) such as: INSTEON, IrDA, Wireless USB, Bluetooth, Z-Wave, ZigBee and Body Area Networks, Ant, Thread, Sigfox or NB-IOT, Lora. Some embodiments may include GPRS interfaces.

It has been explained herein that the accessory 100 may switch to a broadcast mode based on the power level of the electronic device with which it is coupled (e.g. by being secured to that device). However in some embodiments the accessory 100 may switch mode dependant on environmental conditions, location, data density, energy conditions and other conditions sensed by the accessory 100.

With reference to the drawings in general, it will be appreciated that schematic functional block diagrams are used to indicate functionality of systems and apparatus described herein. It will be appreciated however that the functionality need not be divided in this way, and should not be taken to imply any particular structure of hardware other than that described and claimed below. The function of one or more of the elements shown in the drawings may be further subdivided, and/or distributed throughout apparatus of the disclosure. In some embodiments the function of one or more elements shown in the drawings may be integrated into a single functional unit. A variety of embodiments are envisaged. For example although there may be advantages to including, as part of the accessory, a fixture for securing the accessory to an external surface of the housing such a fixture may be made and supplied separately—it need not be integrated with the accessory. In some embodiments it may be omitted altogether. For example, one such accessory comprises: an energy store for storing electrical energy; a power harvester for charging the energy store and comprising an electromagnetic field coupler configured so that when in use the accessory is disposed within range of an electronic device, the electromagnetic field coupler is operable to couple with a time varying electromagnetic field (such as an H-field) generated by operation of the electronic circuitry in the device. As with the other accessories described herein such an accessory may also comprise a data store storing message data; a wireless communication interface, and a controller wherein the wireless communication interface and the controller are coupled to obtain a power supply from the energy store; and a user operable activator, wherein the controller is configured to operate the wireless communication interface to transmit a message based on the message data in response to operation of the user operable activator. Optionally, instead of a fixture for securing the accessory to a housing of an electronic device such an accessory may comprise encapsulation arranged to hold the electromagnetic coupler in a selected position—for example it may comprise a flat base to support the accessory in a stable position on a surface. It may also hold the electromagnetic coupler so that a conduction loop of the coupler is held at a selected angle with respect to that surface—for example the open face for the loop may be either aligned flat with or upstanding from that base. In some embodiments, instead of a fixture or an encapsulation as described above, the accessory may comprise a cradle or seat in which an electronic device can be held. In these embodiments the electromagnetic field coupler may be disposed in the cradle or seat for coupling with a time varying electromagnetic field (such as an H-field) generated by operation of the electronic circuitry in the device.

It will be appreciated in the context of the present disclosure that any of the accessories described herein may have encapsulation such as that described above. In addition, or as an alternative, the electromagnetic coupler may be embedded in an encapsulation/housing of any one of the accessories described or claimed herein.

These accessories may have any one or more of the features of the accessories described and claimed herein, for example the message data may be selected in the same way—e.g. based on at least one of: a number, a duration, and a timing of a series of actuations of the user operable activator.

In some examples, one or more memory elements can store data and/or program instructions used to implement the operations described herein. Embodiments of the disclosure provide tangible, non-transitory storage media comprising program instructions operable to program a processor to perform any one or more of the methods described and/or claimed herein and/or to provide data processing apparatus as described and/or claimed herein. The data stores described herein may comprise volatile and/or non-volatile memory for storing computer readable data and instructions.

The processors and controllers described herein (and the activities they perform) may be implemented with fixed logic such as assemblies of logic gates or programmable logic such as software and/or computer program instructions executed by a processor. Other kinds of programmable logic include programmable processors, programmable digital logic (e.g., a field programmable gate array (FPGA), an erasable programmable read only memory (EPROM), an electrically erasable programmable read only memory (EEPROM)), an application specific integrated circuit, ASIC, or any other kind of digital logic, software, code, electronic instructions, flash memory, optical disks, CD-ROMs, DVD ROMs, magnetic or optical cards, other types of machine-readable mediums suitable for storing electronic instructions, or any suitable combination thereof.

1. An accessory for an electronic device, wherein the electronic device comprises electronic circuitry encapsulated by a housing, the accessory comprising:
a fixture for securing the accessory to an external surface of the housing;
an energy store for storing electrical energy;
a power harvester for charging the energy store and comprising an electromagnetic field coupler configured so that when in use the accessory is secured to the housing, the electromagnetic field coupler is positioned for coupling with a time varying electromagnetic field generated by operation of the electronic circuitry;
a data store storing message data;
a wireless communication interface, and a controller wherein the wireless communication interface and the controller are coupled to obtain a power supply from the energy store; and
a user operable activator,
wherein the controller is configured to operate the wireless communication interface to transmit a message based on the message data in response to operation of the user operable activator.

2. The accessory of claim 1 wherein the message comprises data based on at least one of: an identifier of the accessory; a number of activations, a timing of a series of activations of the user operable activator, and a force applied to the activator.

3. The accessory of claim 1 or 2 wherein the wireless communication interface is operable in a unicast mode to send the message only to a selected communications device, and in a broadcast mode for broadcasting the message.

4. The accessory of claim 3 wherein the controller is configured to determine a power level of the selected communications device and, in the event that the power level is less than a selected threshold level, to operate the wireless communication interface in the broadcast mode.

5. The accessory of any preceding claim wherein the message comprises address data for forwarding the message over a wide area network.

6. The apparatus of any preceding claim wherein the electromagnetic field coupler is further configured to couple with a time varying E-field generated by operation of the electronic circuitry.

7. The apparatus of any preceding claim wherein the electronic device comprises a mobile telecommunications handset and the fixture is adapted for securing the accessory on a case of the handset.

8. The apparatus of claim 7 wherein the fixture comprises part of the case.

9. The apparatus of any preceding claim wherein the short range communication interface comprises a Bluetooth interface.

10. A system comprising:
a mobile telecommunications handset and
an accessory adapted to be secured on a case of the handset, wherein:
the accessory comprises a user operable activator and an energy store for storing electrical energy harvested from the handset, and the accessory is configured to provide signals to the handset via a short range a wireless communication interface, and
the system is configured to transmit a message via a telecommunications interface of the handset in response to actuation of the user operable activator, and
the handset is configured to select the content of the message based on at least one of:
the number of times a user operates the activator during a time interval,
the length of a delay between user operations of the activator during the time interval,
the duration of a single user operation of the activator; and
an actuation force applied to the activator.

11. The system of claim 10 wherein the accessory comprises:
an energy store for storing electrical energy and
a power harvester for charging the energy store and comprising an electromagnetic field coupler configured so that when in use the accessory is secured to a housing of the handset, the electromagnetic field coupler is positioned for coupling with a time varying H-field generated by operation of the handset.

12. The system of claim 11 wherein the accessory comprises a data store storing a plurality of message data items, and the accessory is configured to provide the message data items to the mobile telecommunications handset.

13. The system of claim 11 or 12 wherein the accessory is operable in a unicast mode for communication only with the handset, and in a broadcast mode for broadcasting the message to a plurality of other devices.

14. The system of claim 13 wherein the accessory comprises a controller configured to determine a power level of the handset and, in the event that the power level is less than a selected threshold level, to operate in the broadcast mode.

15. The system of any of claims 11 to 14 wherein the electromagnetic field coupler is further configured to couple with a time varying E-field generated by operation of the handset.

16. The system of any of claims 11 to 15 wherein the accessory is carried on a rear surface of the handset.

17. The system of any of claims 11 to 16 wherein the accessory is configured to harvest power from electromagnetic signals in at least one of: a Wi-Fi frequency band; and a telecommunications frequency band such as a GPRS frequency band or an LTE frequency band.

18. An accessory for an electronic device comprising:
a base for securing the accessory to a housing of the device;
a user operable activator carried on the base,
transducer couplings comprising electrically conductive elements for sensing actuation of the button;
an energy store coupled to the electrically conductive elements; and
a power harvesting antenna for coupling with electromagnetic fields generated by operation of the electronic device for charging the energy store;
wherein the power harvesting antenna lies closer to the base than the transducer couplings.

19. The accessory of claim 18 further comprising a second antenna for short range wireless communications, wherein the second antenna lies between the power harvesting antenna and a superior actuation surface of the button.

20. The accessory of claim 18 or 19 wherein the energy store lies between a plane defined by the power harvesting antenna and a superior actuation surface of the button.
